(19) United States
(12) Patent Application Publication
(10) Pub. No.: US 2017/0206495 A1
(43) Pub. Date: Jul. 20, 2017

(54) Inventory Control Container and System

(71) Applicants: Brian J. RATKOVICH, San Francisco, CA (US); Max N. RATKOVICH, San Francisco, CA (US)

(72) Inventors: Brian J. RATKOVICH, San Francisco, CA (US); Max N. RATKOVICH, San Francisco, CA (US)

(21) Appl. No.: 15/479,994

(22) Filed: Apr. 5, 2017

Related U.S. Application Data
(63) Continuation of application No. 14/990,767, filed on Jan. 7, 2016.

(51) Int. Cl. G06Q 10/08

(52) U.S. Cl. CPC G06Q 10/087; G06Q 10/083; H04W 4/008

(57) ABSTRACT

An inventory control container includes a collapsible container, placeable in a flattened configuration and in a three-dimensional configuration, and a sensing and identification assembly carried by the container and including a sensor and a wireless personal area network device, such as a Bluetooth low energy device. The sensor is mounted to the container and placed in a first state when the container is in the flattened configuration. The network device is operably coupled to the sensor and placeable in a transmit state to generate and transmit a container-empty signal only if the sensor is in the first state. An inventory control container system includes a transceiver and a plurality of the inventory control containers. The transceiver can be located to receive signals from the network devices and configured to process the signals to generate inventory data corresponding to the configurations of the inventory control containers.

### CROSS-REFERENCE

This application is a continuation of U.S. application Ser. No. 14/990,767, titled “Inventory Control Container and System”, filed 7-Jan-2016.

### BACKGROUND OF THE INVENTION

Businesses often have a variety of products that they buy and consume in large quantities. For example, in the restaurant/cafe industry businesses often use large quantities of paper cups, plastic lids, coffee sleeves, napkins, paper plates, etc. The same type of situation can also arise in other businesses, such as dental, accounting and others, as well as in individual homes. Regardless of the industry or product, the ordering, delivery, inventory and reordering process typically proceeds as follows: 1) products are delivered in single use corrugated boxes, 2) as these boxes become empty, they are broken down, which may require the use of a box cutter, and then are thrown away, 3) inventory is manually done, typically several times a week, 4) reordering is done via phone call, text, email or through the Internet.

### BRIEF SUMMARY OF THE INVENTION

One aspect of the present technology relates to an inventory control container, often simply referred to in this application as the box, which can be used by, for example, a supplier of products, also referred to as inventory, to store, transfer and deliver the products to the customer in an efficient, cost-effective manner. The box allows the product supplier to remotely monitor inventory levels, enabling more efficient manufacturing and delivery for the supplier. The box is collapsible, reusable and has a sensing and identification assembly carried by the box. In some examples each sensing and identification assembly can generate a uniquely identifiable signal that can be used to identify a box. In one example the container beacons or transmits a container-empty signal when the container is in a flattened state, indicating that the container is at least substantially empty. In other examples the box transmits a container-empty signal when the box is in the flattened state, indicating that the box is at least substantially empty, and transmits a container-may-not-be-empty signal only if the box is in a three-dimensional state, not in a flattened state. Note that the container may contain some residual product when in a flattened state. Therefore, as used in this application container-empty is intended to cover the situation in which the container is empty and situations in which the container is substantially empty, and placeable in a flattened state.

The box is particularly useful for frequently consumed, high volume, disposable items—such as paper and plastic items used for eating/drinking; office supplies like paper, pens, staples, paperclips; and kitchen and bathroom supplies like soap, detergent, toilet paper. When the box is in the presence of a transceiver, the status of the box can be sent to a central server to allow the inventory to be monitored remotely. A transceiver can include any Machine to Machine (M2M) transceiver such as those built on chipsets conforming to standards such as IEEE 802.15.1 (Bluetooth), IEEE 802.15.4 (Zigbee), or an Ultra-Wide Band (UWB) technology such as Direct Sequence UWB. The present technology can provide one or more of the following advantages: 1) the reusable box is environmentally friendly, 2) in some examples the box collapses on itself with the pull of a string, 3) in the flattened state the box can easily be stored out of the way, 4) the sensors in the boxes provide information as to which boxes are at least substantially empty and which ones are not, so that inventory can be done automatically, 5) when inventory is low and when the status is monitored remotely, reordering can be done automatically, 6) real time inventory levels allow delivery route and delivery vehicle optimization for every delivery, 7) when items are boxed at a manufacturing facility, the network can be immediately notified and a pickup of the product can be seamlessly scheduled. Accordingly, a delivery company can use the data to help make delivery routes more efficient than its competitors, and manufacturers can find the box useful because it helps streamline their supply chain and cuts down on their boxing costs.

A first example of an inventory control container includes a collapsible container and a sensing and identification assembly carried by the container. The collapsible container is placeable in a first, flattened configuration and in a second, three-dimensional configuration. The sensing and identification assembly includes a first sensor and a first wireless personal area network device, the latter referred to as the first network device. The first sensor is carried by the container and placed in a first state when the container is in the first, flattened configuration. The first network device is operably coupled to the first sensor and is placeable in a transmit state to generate and transmit a first, container-empty signal only if the sensor is in the first state. In one example, inventory data is created when the collapsible container is placed in a flattened configuration. Inventory data is measured at the box level, rather than at the quantity of items within the box level. In this example, inventory data indicating an at least substantially empty container is created when the collapsible container is placed in a flattened configuration.

The first example of an inventory control container can include one or more of the following. The first network device can include a Bluetooth low energy device. The first network device can be placed in the transmit state whenever the first sensor is in the first state. The first sensor can include two pairs of electrical contacts; the first state is achieved when the circuit including the two pairs of electrical contacts is closed. The first network device can be placed in the transmit state by the receipt of an interrogation signal. The first network device can be placeable in the transmit state for predetermined transmit times between predetermined periods of time. A battery can power the first network device.

The sensing and identification assembly of the first example can include a second sensor and a second network device. The second sensor can be mounted to the container and placed in a second state when the container is in the second, three-dimensional configuration. The second network device can be operably coupled to the second sensor and placeable in a transmit state to generate and transmit a second, container-may-not-be-empty signal only if the second sensor is in the second state. A first battery can power the first network device and a second battery can power the second network device. The second network device can be placed in the transmit state upon receipt of an interrogation signal. The second network device can be placed in the transmit state whenever the second sensor is in the second state.

An example of inventory control container system includes a transceiver and a plurality of the first example of inventory control containers. The transceiver can be located to receive signals from the first network devices. The transceiver can be configured to process the signals from the first network devices to generate inventory data corresponding to the configurations of the plurality of inventory control containers.

A second example of an inventory control container includes a collapsible container and a sensing and identification assembly carried by the container. The collapsible container is placeable in a first, flattened configuration and a second, three-dimensional configuration. The sensing and identification assembly includes a sensor carried by the container and placed in a first state whenever the container is in the first, flattened configuration and in a second state when the collapsible container is in the second, three-dimensional configuration. The sensing and identification assembly also includes a first and second network devices, operably coupled to the sensor, and a battery powering the first and second network devices. The first network device is placed in a transmit state to generate and transmit a first, container-empty signal whenever the sensor is in the first state. The second network device is placed in a transmit state to generate and transmit a second, container-may-not-be-empty signal whenever the sensor is in a second state.

The second example of an inventory control container can include one or more the following. Each of the first and second network devices can comprise a Bluetooth low energy sensor. The battery can comprise a first battery to power the first network device and a second battery to power the second network device. The sensor can include first and second sensors operably coupled to the first and second network devices and placed in the first state whenever the container is in the first, flattened configuration and in the second state when the container is in the second, three-dimensional configuration, respectively.

A second example of an inventory control container system includes a transceiver and a plurality of the second example of inventory control containers. The transceiver is located to receive signals from the first network devices and the second network devices, and is configured to process the signals from the first and second network devices to generate inventory data corresponding to the configurations of the plurality of inventory control containers.

Other features, aspects and advantages of implementations of this disclosure can be seen on review the drawings, the detailed description, and the claims which follow.

### BRIEF DESCRIPTION OF THE DRAWINGS

FIG. 1 shows a collapsible container in a fully expanded, three-dimensional state suitable for containing a product or products.

FIG. 2 shows the collapsible container of FIG. 1 with the top lifted above the bottom showing the interior of the container.

FIG. 2A is an enlarged view of a portion of the structure of FIG. 2 in which the pairs of contacts of a sensor are spaced apart from one another.

FIG. 3 shows the container of FIG. 2 in a partially collapsed, flattened state.

FIG. 3A is an enlarged view of a portion of the structure of FIG. 3 in which the pairs of contacts of the sensor electrically engage one another.

FIG. 4 shows the container of FIG. 3 in a fully collapsed, flattened state.

FIG. 5 shows the side wall structure of the collapsible container of FIGS. 2 and 3 in a laid out, flattened state.

FIGS. 6A-6B are block diagrams of examples of an inventory control container system.

FIG. 7 is a block diagram for an example computer system.

### DETAILED DESCRIPTION

The following description will typically be with reference to specific structural embodiments and methods. It is to be understood that there is no intention to be limited to the specifically disclosed embodiments and methods but that other features, elements, methods and embodiments may be used for implementations of this disclosure. Preferred embodiments are described to illustrate the technology disclosed, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

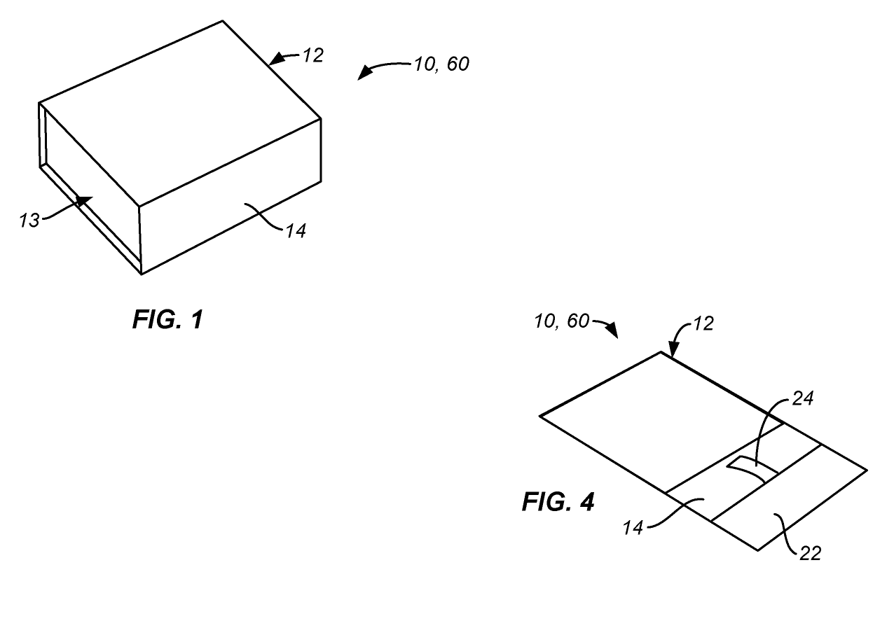

This application will first describe collapsible container 10 with reference to FIGS. 1-4. Collapsible container 10 can be of the type shown in U.S. Pat. No. 8,573,471, the disclosure of which is incorporated by reference. Other box-type collapsible containers can also be used. The container described in this application is made of stiff material hinged together at fold lines to create a relatively rigid box when in the three-dimensional state. However, other types of containers, such as a paper bag which can fold onto itself into a flattened configuration and a flexible plastic bag which can collapse into a flattened configuration, can also be used.

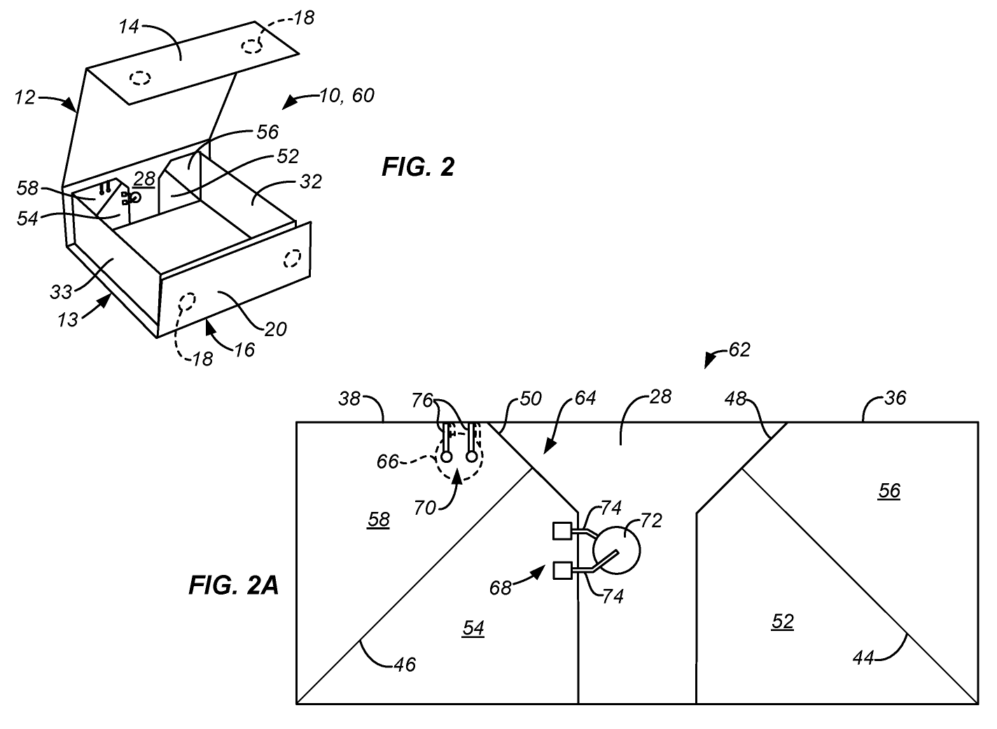

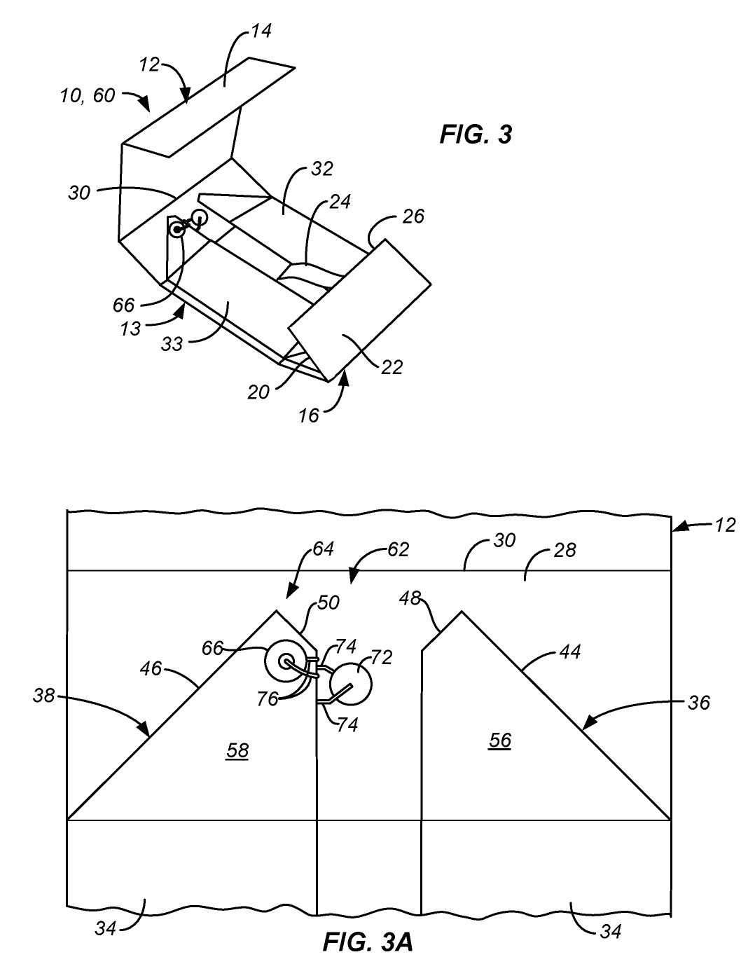

FIGS. 1 and 2 show container 10 in a fully expanded, three-dimensional state suitable for containing one or more products. Container 10 has a top 12 and a bottom 13. Top 12 includes a front flap 14 which can be placed in front of and adjacent to a front wall 16 of bottom 13 to be temporarily secured in place through the use of magnetic elements 18 embedded within front flap 14 and front wall 16. Front wall 16 is a two layer wall having an outer layer 20 and an inner layer 22, inner layer 22 shown in FIGS. 3 and 4. A length of material 24 extends from an edge 26 of inner layer 22. Pulling on material 24 moves inner layer 22, which is positioned parallel to and abutting outer layer 20 when in the fully expanded, three-dimensional configuration of FIGS. 1 and 2, away from outer layer 20 to permit transformation of container 10 from the fully expanded, three-dimensional configuration of FIGS. 1 and 2, to the partially collapsed, flattened configuration of FIG. 3, and then on to the fully collapsed, flattened configuration of FIG. 4. As used in this application, a container in a flattened configuration, also referred to as a flattened state, need not be completely flat but is sufficiently flattened so that it no longer acts as a container for a product or as a container for more than an insubstantial amount of the product. For example, when a product is a thin product, such as an advertising flyer or a postcard, a container in a flattened configuration could contain several advertising flyers or postcards and still be placeable in a flattened state.

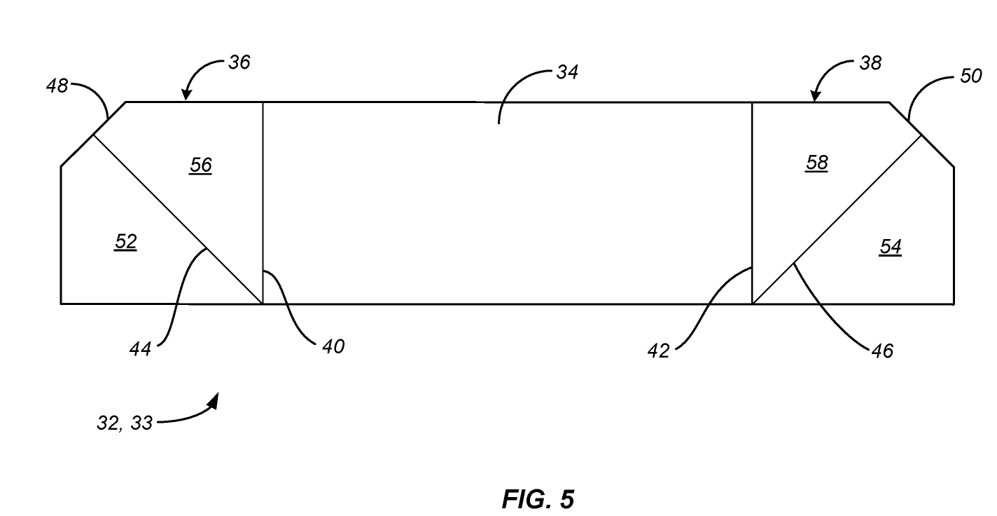

Bottom 13 also includes a rear wall 28 having an edge 30 from which top 12 extends. Outer layer 20 of front wall 16 and rear wall 28 are connected by two sidewall structures 32, 33. Sidewall structures 32, 33 are identical so that the following description will be primarily with reference to sidewall structure 32. FIG. 5 shows sidewall structure 32 in a laid out, flattened state. Sidewall structure 32 has a central portion 34 and first and second end portions 36, 38 joined by fold lines 40, 42. End portions 36, 38 have diagonal fold lines 44, 46 extending from the lower ends of fold lines 40, 42 to chamfered corners 48, 50. End portions 36, 38 are each divided into outer end portions 52, 54 and inner end portions 56, 58 by fold lines 44, 46. Outer end portions 52, 54 of respective sidewall structures 32, 33 are adhered to rear wall 28 while outer end portions 54, 52 of respective sidewall structures 32, 33 are adhered to outer layer 20 of front wall 16. This construction permits collapsible container 10 to be transformed from the fully expanded, three-dimensional state of FIGS. 1 and 2 to the fully collapsed, flattened state of FIG. 4, and back again.

Collapsible container 10 is transformed into an inventory control container 60, sometimes referred to as box 60, through the addition of a sensing and identification assembly 62. Assembly 62, in this example, includes a sensor 64 and a wireless personal area network device 66, typically referred to as network device 66. In this example sensor 64 includes two sets of electrical contacts 68, 70 used to sense when container is in the flattened state. FIG. 2A is an enlarged view of a portion of the structure of FIG. 2 showing the interior surface of rear wall 28 and end portions 36, 38 of sidewall structures 32, 33. As shown in FIG. 2A, contacts 68 are mounted to the outer end portion 54 of end portion 38 and contacts 70 are mounted to the inner end portion 58 of end portion 36. A battery 72 is mounted to rear wall 28 and is connected to contacts 68 by wires 74. Network device 66 is mounted to the opposite side of inner end portion 58 as illustrated in dashed lines in FIG. 2A. Network device 66 is connected to contacts 70 by wires 76.

Contacts 68, 70 contact to one another, thus supplying power from battery 72 to network device 66, when the container 10 is in the fully collapsed, flattened state of FIG. 4. Container 10 is placed in the fully collapsed, flattened state of FIG. 4 from the state of FIG. 3 by folding top 12 down onto bottom 13, and folding inner layer 22 of front wall 16 down onto outer layer 20 of front wall 16. In some examples contacts 68, 70 contact one another shortly before container 10 is in the fully collapsed, flattened state of FIG. 4, such as shown in FIG. 3. An enlarged view of a portion of the structure of FIG. 3 is shown in FIG. 3A.

In this example network device 66 can be a Bluetooth low energy device, such as Nordic nRF24LE1 System On a Chip (SOC) available from Nordic Semiconductor of Oslo, Norway. Other network devices, such as the CC2540 BLE SOC available from Texas Instruments can also be used.

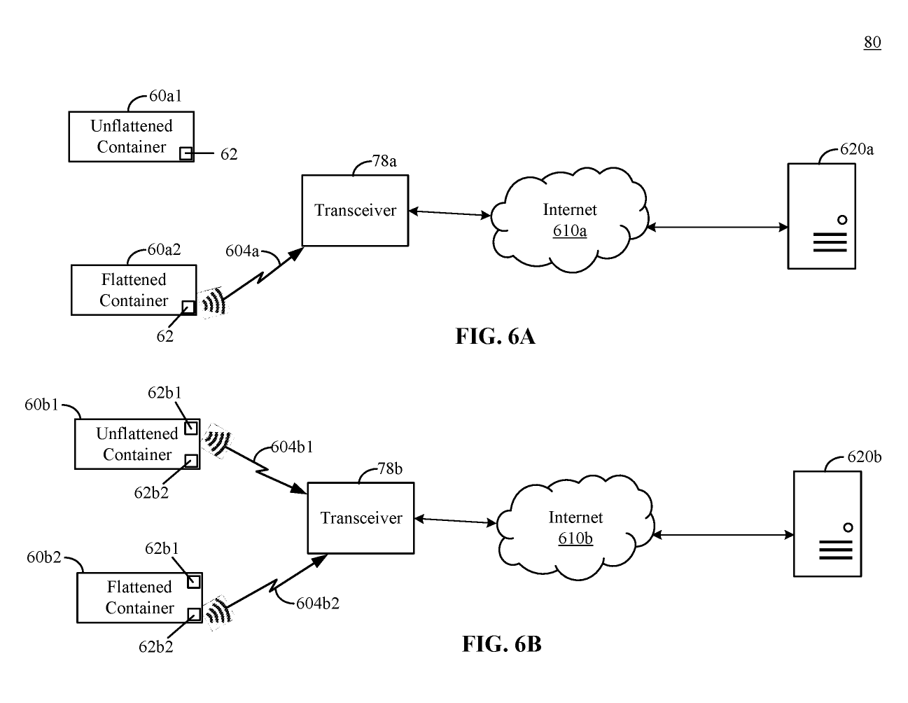

In this example sensor 64 is in the form of contacts 68, 70 which connect to one another when container 10 is in a flattened state. This energizes network device 66 causing it to generate and transmit a container-empty signal, signified by signal 604a and signal 604b, collectively known as signal 604, in FIG. 6, whenever container 10 is in a flattened state. In this example the sensor is actuated when two different layers of material constituting portions of container 10 lie against one another, which occurs when the container is in a flattened state but not otherwise.

In some examples network device 66 could be configured to only periodically generate and transmit a container-empty signal while container 10 is in the flattened state as a power-saving measure. For example, network device 66 could be placeable in the transmit state for predetermined transmit times separated by predetermined non-transmit periods of time.

Other types of sensors, such as pressure sensors, can also be used. In addition, the sensor could be of the type which would be actuated by sensing when the angle between top 12 and a bottom 13 along edge 30 approaches 0°, as occurs when container 10 is in the fully collapsed, flattened state of FIG. 4. In this example the sensor could include stiff but flexible length of material extending along top 12 and bottom 13 having ends aligned with one another and adjacent to edge 30. The lengths of material would each have an electrical contact at its distal end. When container 10 is in the three-dimensional state of FIGS. 1 and 2, the distal ends of the lengths of material would overlap sufficiently so that the electrical contacts would not contact one another. But when the container is in the flattened state, the ends of the lengths of material would be drawn towards one another so that contacts at the ends would engage completing the circuit. Such a sensor would be especially useful if container 10 does not have layers of material which lie against one another when the container is in a fully collapsed, flattened state. Sensor 64 could have magnetically actuated contacts. The sensing and identification assembly 62, including sensor 64 and network device 66, could also be carried by the container by being embedded within the walls of the box to be substantially or completely hidden from view. This would help eliminate tampering and inadvertent damage to assembly 62. Further, the sensor could use a gyroscope/accelerometer mounted to or otherwise carried by different walls of the box so to signal the orientation of the different walls of the box. When the orientations of the walls of the box are arranged in a certain way, you would know if the box is in a flattened or a three-dimensional state.

In some examples network device 66 could include its own battery so that sensor 64 could simply be structure for completing a circuit allowing the battery to energize network device 66 when container 10 is in a flattened state. In such example network device 66 could generate and transmit a container-empty signal when container 10 is in the flattened state or it could generate and transmit a container-empty signal when container is in the flattened state and a container-might-not-be-empty signal otherwise.

Although it is presently preferred that network device 66 be an active or powered network device, it could be a passive network device of the type including an antenna the response we signal their oscillations captured by the antenna to generate and transmit a container-empty signal upon receipt of an interrogation signal when container 10 is in a flattened state. The interrogation signal can be any signal agreed upon between the transceiver and the network device 66, where the network device 66 can respond to the interrogation signal with a predetermined response. Network device 66 could also be a hybrid network device; such a device would be a powered device but would not constantly transmit signals. For example, the system could begin transmitting signals only after an initial period of time and/or at periodic intervals, both to save power.

In some examples container 10 could also include a passive device, such as RFID tag, which would be used not to determine if the container is in a three-dimensional or a flattened configuration, but rather to determine the simple presence of one or more containers 10. This could be useful as part of a theft deterrent system. Such passive devices could also be used to determine for the presence of a particular container, such as for inventory purposes.

In some examples a second sensing and identification assembly 62 could be used provide container-not-empty signal whenever container 10 is in the fully expanded, three-dimensional state of FIGS. 1 and 2. This could be accomplished by, for example, using a sensing and identification assembly corresponding to assembly 62 discussed above. A first set of contacts 68 can be mounted on the surface of inner layer 22 facing the opposed surface of end portion 36. A second set of contacts 70 can be mounted on the surface of end portion 36 facing inner layer 22. Contacts 68, 70 would be located so that they contact one another and complete the circuit between battery 72 and network device 66 when the container 10 is in the fully expanded, three-dimensional state of FIGS. 1 and 2. In this example inventory control container 60 would provide a container-may-not-be-empty signal when container 60 is in the fully expanded, three-dimensional state of FIGS. 1 and 2, and a container-empty signal when inventory control container 60 is in a flattened state as illustrated in FIGS. 3 and 4. See FIG. 6B discussed below.

One or more inventory control containers 60 can be used with a transceiver 78 to create an inventory control container system 80. See FIG. 6.

FIGS. 6A-6B, collectively known as FIG. 6, are block diagrams of two examples of inventory control container systems 80. In one implementation, FIG. 6A is a schematic representation of an inventory control container system 80 comprising a plurality of inventory control containers with two inventory control containers 60a1, 60a2 being illustrated. In this example, each inventory control container 60a1, 60a2 contains a sensing and identification assembly 62. The sensing and identification assembly in the three-dimensional, unflattened container 60a1, which can contain useable inventory, is not transmitting a signal to a transceiver 78a, and the flattened container 60a2, which typically have no longer contains useable inventory, is transmitting a signal 604a to the transceiver 78a. The unflattened configuration is also referred to as the three-dimensional configuration. The signal 604a can be a continuous signal, or can be an intermittent signal to reduce battery consumption. The transceiver 78a can then transmit the information derived from the signal 604a to a computer 620a through the Internet 610a. The computer 620a can identify a flattened inventory control container 60a2 by its unique signal. In one example, this can trigger a reorder of inventory as a replacement for the flattened container 60a2. In another example, an instruction to collect the flattened container 60a2 can be generated instead of or in addition to a reorder instruction.

In another implementation, FIG. 6B is a schematic representation of an inventory control container system comprising a plurality of inventory control containers 60b1, 60b2. In this example, each inventory control container 60b1, 60b2 contains two sensing and identification assemblies 62b1, 62b2. The sensing and identification assembly 62b1 in the unflattened container 60b1 is transmitting a container-may-not-be-empty signal 604b1 to a transceiver 78b, which informs the transceiver 78b that the unflattened container 60b1 is in proximity to transceiver 78b. The signal 604b1 can be a continuous signal, or can be an intermittent signal to reduce battery consumption. The sensing and identification assembly 62b2 of inventory control container 60b1 is not transmitting a signal to the transceiver 78b, as the circuit in the unflattened container 60b1 has not been closed. The transceiver 78b can then transmit the information derived from the signal 604b1 to a computer 620b through the Internet 610b. The computer 620b can identify the unflattened inventory control container 60b1 by its unique signal. In one example, this can trigger a “device found” transaction, which can indicate that the unflattened container 60b1 is in proximity to the transceiver 78b.

Instead of transmissions using Internet 610, transmission could be through a private network, a type of cell network, a machine-to-machine network, or other system, known or developed in the future, for transferring information electronically. Although transmission of electronic signals is expected to be primarily wireless transmission, in some situations, such as for enhanced data security, the transmissions can be by wired transmission.

In another example, a sensing and identification assembly 62b1 in a flattened container 60b2 is not transmitting a signal to a transceiver 78b, as the circuit in the flattened container associated with the sensing and identification assembly 62b1 is not closed. The sensing and identification assembly 62b2 is transmitting a signal to the transceiver 78b, as the circuit associated with the sensing and identification assembly 62b2 in the flattened container 60b2 has been closed. The signal 604b2 can be a continuous signal, or can be an intermittent signal to reduce battery consumption.

One example of a process for generating the container-empty signal, or both the container-empty signal and the container-might-not-be-empty signal, can proceed generally as follows. Once the circuit is closed, network device 66 is activated. This causes network device 66 to generate and transmit a container-empty signal/container-might-not-be-empty signal; in either case the signal would include its unique ID.

Another example of a process for generating the container-empty signal, or both the container-empty signal and the container-might-not-be-empty signal, can proceed generally as follows. Once the circuit is closed, network device 66 is activated. Upon receipt of a signal transmitted by the transceiver 78, sometimes called an interrogation signal, network device 66 generates and transmits a container-empty signal/container-might-not-be-empty signal; in either case the signal would include its unique ID.

The transceiver 78b can then transmit the information derived from the signal 604b2 to a computer 620b through the Internet 610b. The computer 620b can identify the flattened inventory control container 60b2 by its unique signal. In one example, this can trigger a reorder of inventory as a replacement for the flattened container 60b2. In another example, an instruction to collect the flattened container 60b2 can be generated. In some examples both instructions are generated.

The transceiver 78b can also inform the computer 620b when it no longer receives an unflattened, container-may-not-be-empty signal from a sensing and identification assembly 62b1 from an inventory control container 60b1, 60b2. This can indicate an event such as a problem with the sensing and identification assembly, or the removal of the sensing and identification assembly from proximity to the transceiver 78b.

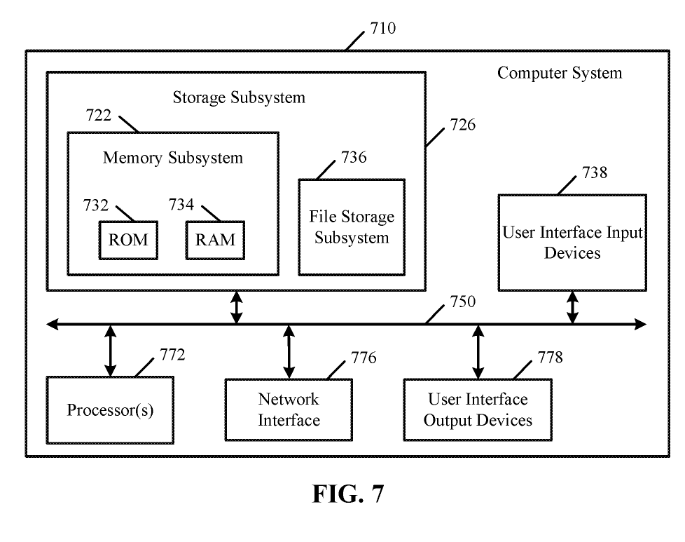

FIG. 7 is a block diagram of an example computer system, according to one implementation. The processor can be an ASIC or RISC or ARM processor. It can be an FPGA or other logic or gate array. It can include graphic processing unit (GPU) resources. Computer system 710 typically includes at least one processor 772 that communicates with a number of peripheral devices via bus subsystem 750. These peripheral devices can include a storage subsystem 726 including, for example, memory devices and a file storage subsystem, customer interface input devices 738, customer interface output devices 778, and a network interface subsystem 776. The input and output devices allow user interaction with computer system 710. Network interface subsystem 776 provides an interface to outside networks, including an interface to corresponding interface devices in other computer systems.

User interface input devices 738 can include a keyboard; pointing devices such as a stylus, mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 710.

User interface output devices 778 can include a display subsystem, a printer, a fax machine, or non-visual displays such as audio output devices. The display subsystem can include an e-ink screen, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 710 to the user or to another machine or computer system.

Storage subsystem 726 stores programming and data constructs that provide the functionality of some or all of the modules and methods described herein. These software modules are generally executed by processor 772 alone or in combination with other processors.

Memory 722 used in the storage subsystem can include a number of memories including a main random access memory (RAM) 734 for storage of instructions and data during program execution and a read only memory (ROM) 732 in which fixed instructions are stored. A file storage subsystem 736 can provide persistent storage for program and data files, and can include a hard disk drive, a disk drive along with associated removable media, a CD-ROM drive, an optical drive, or removable media cartridges. The modules implementing the functionality of certain implementations can be stored by file storage subsystem 736 in the storage subsystem 726, or in other machines accessible by the processor.

Bus subsystem 750 provides a mechanism for letting the various components and subsystems of computer system 710 communicate with each other as intended. Although bus subsystem 750 is shown schematically as a single bus, alternative implementations of the bus subsystem can use multiple busses. Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as one example. Many other configurations of computer system 710 are possible having more or fewer components than the computer system depicted in FIG. 7.

The examples described above should not be taken as limiting or preferred. These examples sufficiently illustrate the technology disclosed without being overly complicated, and are not intended to illustrate all embodiments of the technology disclosed. A person having ordinary skill in the art will appreciate that there are many potential applications for one or more implementations of this disclosure.

One of ordinary skill in the art can appreciate that a computer or other client device can be deployed as part of a computer network. In this regard, the technology disclosed pertains to any computer system having any number of memory or storage units, and any number of applications and processes occurring across any number of storage units or volumes. The technology disclosed can apply to an environment with server computers and client computers deployed in a network environment, having remote or local storage. The technology disclosed can also apply to a standalone computing device, having programming language functionality, interpretation and execution capabilities.

The technology disclosed can be implemented in the context of any computer-implemented system including a database system, a multi-tenant environment, or the like. Moreover, this technology can be implemented using two or more separate and distinct computer-implemented systems that cooperate and communicate with one another. The disclosed technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

The technology disclosed herein is particularly useful for vertically integrated manufacturers of high volume disposable goods which deliver their products from the factory to the end user. The technology, when used with a vertically integrated, direct to consumer business model, allows the use of a reusable box in a way that makes sense—in one round trip products can be delivered to a customer who has run out of a product and the empty boxes can be collected for return to the factory for refilling. In contrast, a conventional manufacturer using a reusable box would typically need to use a third party to collect the empty boxes; this would most likely be cost prohibitive. The technology disclosed herein provides a further significant advantage by eliminating the task of having to do inventory. Even if a manufacturer is not vertically integrated with the distribution process, the technology disclosed herein can still be beneficial; when goods are manufactured, boxed and delivered, anyone involved in that process could find the technology disclosed herein to be particularly useful.

The above descriptions may have used terms such as above, below, top, bottom, over, under, et cetera. These terms may be used in the description and claims to aid understanding what is being disclosed and not used in a limiting sense.

While implementations of the technology are disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the technology disclosed and the scope of the following claims. Examples follow.

Sensing and identification assembly 62 could be in the form of a button-like, unitary, self-contained assembly 62 which could be mounted to the inside surface of either of the inner end portions 56 or 58. Such a unitary, self-contained assembly 62 could include a pressure sensitive switch. When container 60 is in the flattened configuration, the unitary, self-contained assembly 62 would be squeezed between and against the opposed outer end portion 52 or 54 thus causing closing of the pressure sensitive switch and the generation and transmission of a flattened container signal 604a.

In some examples the same network device 66 could act as first and second network devices 66 and be used to generate both the container-empty signal and the container-night-not-be empty signal according to the status of one or more sensors 64.

Also, for additional security container 10 can be provided with a locking mechanism, such as a magnetic lock mechanism, for transporting valuable products.

The above-described examples are typically discussed as part of a commercial enterprise supplying consumable products to a business. As part of this process the container 10 would typically be owned by the party supplying the product, not the customer. According to another example, container 10 could be purchased by an individual, as well as by a business organization, typically as an aid in knowing when to repurchase a particular product while at a remote location. For example, the user could have three types of containers 10 used to separately contain dog treats, single cup coffee pods and a favorite snack. With a transceiver 78 in proximity to container 10, the transceiver could communicate to a computer 620 in the form of a smart phone or pad computer containing appropriate software, typically in the form of an appropriate app, the user would have instant access to the status of the three types of containers 10 when at a store. This can be especially useful when the person purchasing the products is not involved in the use of some or all of the products and therefore would not have first-hand knowledge about when the supply of a particular product was running low. It also eliminates problems associated with forgetting to pick up a shopping list before going shopping as well as forgetting to add products to a shopping list.

One or more elements of one or more claims can be combined with elements of other claims.

Any and all patents, patent applications and printed publications referred to above are incorporated by reference.

What is claimed is:

1. A method for reducing shipping packaging waste and inventory monitoring, comprising:
providing a user with a supply of a product in a reusable collapsible container with the container in an uncollapsed three-dimensional configuration, wherein:
the container is capable of being placed in a flattened configuration when the product has been removed therefrom, and
the container includes a transmitter, a receiver and a sensor configured to sense both of the container in the uncollapsed three-dimensional configuration and the container in the flattened configuration;
receiving, by a transceiver and from the transmitter of the container, a container status signal that (i) includes unique identification information identifying the container, (ii) indicates that the container is in the uncollapsed three-dimensional configuration as a result of the sensor sensing that the container is in the uncollapsed three-dimensional configuration and (iii) indicates that the container is in the flattened configuration as a result of the sensor sensing that the container is in the flattened configuration;
identifying the container from the unique identification information included in the received container status signal;
determining that the container is in the uncollapsed three-dimensional configuration as a result of the received container status signal indicating that the container is in the uncollapsed three-dimensional configuration;
determining that the container is in the flattened configuration as a result of the received container status signal indicating that the container is in the flattened configuration; and
responding to the determination that the container is in the flattened configuration by at least one of (i) retrieving the container that was provided to the user and (ii) providing the user with a further supply of the product in another reusable collapsible container.

2. The method of claim 1, further comprising transmitting, from the transceiver, an interrogation signal to be received by the receiver of the container.

3. The method of claim 2, wherein the container status signal is received by the transceiver as a result of the container receiving the interrogation signal.

4. The method of claim 2, further comprising determining that there is a problem with the sensor of the container as a result of the container status signal not being received from the transmitter of the container after a predetermined amount of time has expired since the interrogation signal has been transmitted.

5. The method of claim 2, further comprising determining that the container has been placed in an inventory of the user according to the received container status signal.

6. The method of claim 5, further comprising, after a predetermined amount of time has expired since the interrogation signal has been transmitted, determining that the container previously placed in the inventory has been removed from the inventory as a result of the container status signal not being received from the transmitter of the container.

7. The method of claim 1, further comprising determining that the container has been placed in an inventory of the user according to the received container status signal.

8. The method of claim 7, further comprising determining that the container, which was previously determined to have been placed in the inventory, has been removed from the inventory as a result of another container status signal not being received after a predetermined amount of time.

9. The method of claim 1,
wherein a flap of the container includes a second sensor comprising at least one of a gyroscope and an accelerometer, and
wherein the method further comprises determining a location or an orientation of the flap of the container based on information received from the at least one of the gyroscope and the accelerometer of the second sensor.

10. The method of claim 9, further comprising determining whether the container is in the uncollapsed three-dimensional configuration or in the flattened configuration according to the determined location or orientation of the flap of the container.

11. The method of claim 1,
wherein a flap of the container contains the sensor and the sensor includes at least one of a gyroscope and an accelerometer, and
wherein the sensor is configured to sense that the container is in the uncollapsed three-dimensional configuration and that the container is in the flattened configuration according to a location or orientation of the flap of the container determined from information received from the at least one of the gyroscope and the accelerometer.

12. The method of claim 1, further comprising determining a type of the product provided in the container from information included in the received container status signal.

13. The method of claim 1, wherein the responding to the determination that the container is in the flattened configuration includes (i) retrieving the container that was provided to the user and (ii) providing the user with the further supply of the other product in the other reusable collapsible container.

14. The method of claim 1, wherein the responding to the determination that the container is in the flattened configuration includes waiting for a determination that a second container is in the flattened configuration and then (i) retrieving the container that was provided to the user and (ii) providing the user with the further supply of the other product in the other reusable collapsible container.

15. The method of claim 1, further comprising:
determining whether the container status signal has been received by (i) the transceiver, (ii) another transceiver or (iii) both the transceiver and the other transceiver; and
determining a location of the container based on whether the container status signal has been determined to have been received by (i) the transceiver, (ii) the other transceiver or (iii) both the transceiver and the other transceiver.

16. The method of claim 15,
wherein the transceiver is located at a first location and the other transceiver is located at a second location, and
wherein the determining of the location of the container includes determining whether the transceiver is located at the first location, the second location or another location.

17. The method of claim 1, further comprising:
providing a plurality of the reusable collapsible containers to the user, wherein each reusable collapsible container of the plurality of the reusable collapsible containers includes a same product as the remaining reusable collapsible containers of the plurality of the reusable collapsible containers;
monitoring inventory levels of the user by repeatedly determining, for each identified reusable collapsible container of the plurality of the reusable collapsible containers, whether the container is in the flattened configuration or the uncollapsed three-dimensional configuration;
determining that inventory is low when a number of remaining reusable collapsible containers, of the plurality of the reusable collapsible containers, determined to be in the uncollapsed three-dimensional configuration falls below a predefined threshold; and
providing the user with the further supply of the product in the other reusable collapsible container as a result of the inventory being low.

18. The method of claim 17,
further comprising determining a most efficient route for providing the user with the further supply of the product and for providing another user with a supply of the product or another product,
wherein the providing of the further supply to the user includes providing the user with the further supply and providing the other user with the supply according to the most efficient route.

19. The method of claim 1,
wherein the sensor is configured to sense that the container is in the flattened configuration as a result of an amount of the product remaining in the container causing the container to be substantially empty, but not completely empty,
wherein the method further includes determining a delivery date to deliver the further supply of the product in the other reusable collapsible container, such that the determined delivery date is on or near an expected date that the container is expected to be completely empty, and
wherein the method further includes providing the user with the further supply of the product in the other reusable collapsible container on the determined delivery date.

20. A non-transitory computer readable storage medium impressed with computer program instructions to reduce shipping packaging waste and perform inventory monitoring, the instructions, when executed on a processor, implement a method comprising:
providing a user with a supply of a product in a reusable collapsible container with the container in an uncollapsed three-dimensional configuration, wherein:
the container is capable of being placed in a flattened configuration when the product has been removed therefrom, and
the container includes a transmitter, a receiver and a sensor configured to sense both of the container in the uncollapsed three-dimensional configuration and the container in the flattened configuration;
receiving, by a transceiver and from the transmitter of the container, a container status signal that (i) includes unique identification information identifying the container, (ii) indicates that the container is in the uncollapsed three-dimensional configuration as a result of the sensor sensing that the container is in the uncollapsed three-dimensional configuration and (iii) indicates that the container is in the flattened configuration as a result of the sensor sensing that the container is in the flattened configuration;
identifying the container from the unique identification information included in the received container status signal;
determining that the container is in the uncollapsed three-dimensional configuration as a result of the received container status signal indicating that the container is in the uncollapsed three-dimensional configuration;
determining that the container is in the flattened configuration as a result of the received container status signal indicating that the container is in the flattened configuration; and
responding to the determination that the container is in the flattened configuration by at least one of (i) retrieving the container that was provided to the user and (ii) providing the user with a further supply of the product in another reusable collapsible container.

21. A system including a transceiver and a server both including one or more processors coupled to memory, the memory loaded with computer instructions to reduce shipping packaging waste and perform inventory monitoring, the instructions, when executed on the processors, implement actions comprising:
providing a user with a supply of a product in a reusable collapsible container with the container in an uncollapsed three-dimensional configuration, wherein:
the container is capable of being placed in a flattened configuration when the product has been removed therefrom, and
the container includes a transmitter, a receiver and a sensor configured to sense both of the container in the uncollapsed three-dimensional configuration and the container in the flattened configuration;
receiving, by a transceiver and from the transmitter of the container and at the transceiver, a container status signal that (i) includes unique identification information identifying the container, (ii) indicates that the container is in the uncollapsed three-dimensional configuration as a result of the sensor sensing that the container is in the uncollapsed three-dimensional configuration and (iii) indicates that the container is in the flattened configuration as a result of the sensor sensing that the container is in the flattened configuration; and
identifying, by one of the transceiver and the server, the container from the unique identification information included in the received container status signal;
determining, by one of the transceiver and the server, that the container is in the uncollapsed three-dimensional configuration as a result of the received container status signal indicating that the container is in the uncollapsed three-dimensional configuration;
determining, by one of the transceiver and the server, that the container is in the flattened configuration as a result of the received container status signal indicating that the container is in the flattened configuration; and
responding, by one of the transceiver and the server, to the determination that the container is in the flattened configuration implementing at least one of (i) retrieving the container that was provided to the user and (ii) providing the user with a further supply of the product in another reusable collapsible container.

22. A method for reducing shipping packaging waste and inventory monitoring, comprising:
providing a user with a supply of a product in a reusable collapsible container with the container in a three-dimensional configuration, wherein the container is capable of being placed in a flattened configuration as a result of the product having been removed therefrom;
monitoring a location of the container through a signal generated by the container;
monitoring for a container-empty signal from the container as a result of the container being in the flattened configuration; and
determining a response to the container-empty signal including at least one of (i) retrieving the container, and (ii) repeating the providing step.
